(19) United States
(12) Patent Application Publication
(10) Pub. No.: US 2009/0211451 A1
(43) Pub. Date: Aug. 27, 2009

(54) Ductless fumehood system

(76) Inventor: Francois P. Hauville, North Andover, MA (US)

Correspondence Address: Mark J. Pandiscio;Pandiscio & Pandiscio, P.C., 470 Totten Pond Road, Waltham, MA, 02451-1914, US

(21) Appl. No.: 12/072,538

(22) Filed: Feb. 27, 2008

(51) Int. Cl. B08B 15/02; B01D 46/00

(52) U.S. Cl. 95/286; 55/482; 55/471; 96/108; 96/420

(57) ABSTRACT

A modular filtration column for use with a ductless fumehood, the modular filtration column comprising:
a plurality of cassettes having an identical footprint;
at least one of the cassettes being configured to move air through the modular filtration column;
at least one of the cassettes being configured to filter air moving through the modular filtration column; and
at least one seal mechanism for providing an air-tight seal between adjacent cassettes, wherein the at least one seal mechanism is configured to form an air-tight seal devoid of any external compressive force.

### FIELD OF THE INVENTION

This invention relates to air filtration systems in general, and more particularly to modular, ductless fumehoods for purging hazardous substances from the air.

### BACKGROUND OF THE INVENTION

Air filtration systems are used in many situations to purge unwanted substances from the air. Such air filtration systems generally exist in a variety of forms, depending upon their use and function.

One type of air filtration system is the ductless fumehood. Ductless fumehoods provide a protected enclosure for isolating a workspace from an ambient atmosphere, in order that dangerous substances may be handled safely in the workspace without endangering nearby personnel and the surrounding environment.

More particularly, and looking now at FIG. 1, there is shown a typical prior art ductless fumehood 5. Ductless fumehood 5 generally comprises an enclosed workspace 10 accessed by a front door 15, with front door 15 engaging a sash 20 when the enclosed workspace is “sealed”. An air inlet 25 admits ambient air into enclosed workspace 10, and an air outlet 30 removes air from enclosed workspace 10. Air from air outlet 30 is passed through a filter 35 before being released to the ambient air (e.g., the room air within a laboratory). Filter 35 removes hazardous substances from the air, thereby rendering the air safe before it is vented to the ambient air. An outlet fan 40 is generally provided at air outlet 30 so as to keep enclosed workspace 10 at a negative pressure differential relative to the ambient air, in order to ensure that any air within the enclosed workspace passes through filter 35 before being vented to the ambient air. A sensor 45 is generally provided at the outlet of filter 35 so as to ensure that the filter purges any hazardous substances from the workspace air before that air is then vented to the ambient air. Outlet fan 40 and sensor 45 are generally connected to an alarm 50 which can alert the operator in the event that outlet fan 40 and/or sensor 45 fail.

Ductless fumehoods have become popular due to their technical effectiveness, low acquisition and implementation costs, rapid installation, and substantial energy savings. More particularly, with proper filter selection, ductless fumehoods can be extremely effective in removing hazardous materials from the air. Furthermore, due to their simple design and their ductless nature, ductless fumehoods are relatively inexpensive to buy and relatively inexpensive to implement, since they do not require the extensive engineering and installation efforts normally associated with ducted fumehoods. Furthermore, installation is very fast, since ductless fumehoods require little more than uncrating and initial setup and testing before use. Ductless fumehoods are also quite energy efficient, since they return the filtered air to the room rather than venting it to the outside atmosphere. As a result, already-heated air is retained in the room during winter and already-cooled air is retained in the room during summer.

Despite the significant advantages associated with ductless fumehoods, current ductless fumehoods have nonetheless encountered certain resistance in the marketplace. This is generally due to concerns about the risk of failure in the filtration system. More particularly, while conventional ductless fumehoods generally have their outlet fan 40 and sensor 45 connected to an alarm 50 which can alert the operator if outlet fan 40 and/or sensor 45 should fail, they still require that the operator be in the general vicinity of the ductless fumehood and that the operator be somewhat attentive. This can be of concern when the ductless fumehood is located in a loud and/or otherwise distracting environment, and/or when placed in the hands of poorly trained and/or unreliable personnel. Furthermore, this can present an administrative problem when the ductless fumehoods are deployed in large numbers and dispersed throughout several laboratories. Due to these concerns and inconveniences, some safety organizations have advised against the use of ductless fumehoods even though ductless fumehoods can offer significant advantages in the areas of technical effectiveness, low acquisition and implementation costs, rapid installation, and substantial energy savings.

In addition to the foregoing, current ductless fumehoods are not modular. As a result, when a new fumehood model with a different filter capacity must be produced, manufacturers must fabricate a new housing and filtration system, as well as all of the necessary command and control elements. Thus, manufacturers must provide filtration systems in a variety of capacities and dimensions, which multiplies both the number of different fumehood models which must be manufactured as well as their associated manufacturing costs. Furthermore, the administrative burden associated with managing a large number of these ductless fumehoods can be enormous. As an illustration of this problem, consider the example of trains without cars, made up only of locomotives, with each locomotive having a different seating capacity. The cost of manufacturing large numbers of different models, and the administrative burdens associated with managing a fleet of such trains, made up of countless different models, can be prohibitive. The situation is currently somewhat analogous for the manufacturers and users of conventional ductless fumehoods.

In addition to the foregoing, currently-available ductless fumehoods are configured with the filter or filters enclosed inside the fumehood housing. The fumehood housing houses the filter(s), fan and/or blower, and ensures the “air tightness” of the filtration system. This air tightness is effected either by providing (i) a fumehood housing design which pressure seals the filter(s), or (ii) an incorporated or external mechanical tightening mechanism. Regardless of which prior art sealing system is used, the filter(s) are always contained within a fumehood housing which also includes the fans and/or blowers.

Such a configuration has the negative effect of dictating the thickness of the housing according to the thickness of the one or more of the filters (and the associated fan and/or blower). Therefore, and as discussed above, a unique housing must be provided for each specific configuration of filtering system.

Additionally, it should be appreciated that many factors currently contribute to the overall configuration of a ductless filtration system and its associated fumehood housing. By way of example but not limitation, the following factors are all dependent on a specific filtration application: (i) the number of filters; (ii) the surface size (or “footprint”), the thickness and type of each filter; and (iii) the type of fan and/or blower. Furthermore, when configuring each filtration system and its associated fumehood housing, one must also consider whether air is being blown out of the system or pulled in through the system, and also whether positive pressure or negative pressure (or some combination of both) is being applied. Specific filtration systems (e.g., filter type, size and number, fan/blower configurations, etc.) are frequently constrained by the need to match them with available fumehood housings, and likewise, specific fumehood housings may be dictated by specific filtration systems.

From a manufacturing standpoint, it is understandable that fumehood housings are typically produced in standard, pre-determined sizes. As indicated above, it is effectively impossible for a manufacturer to produce all of the varying types and sizes of fumehood housings necessary to meet the specific needs of every conceivable filtration system which may be desired.

Another limitation of currently-available filtration systems is that, once manufactured, the filtration system and fumehood housing cannot thereafter be adapted to accommodate varying filter thicknesses, or additional filters, etc. if there is a subsequent change in fumehood application or use. Likewise, currently-manufactured filtration system/fumehood housing combinations typically cannot satisfy a wide range of application needs, since current constructions cannot be configured to simultaneously accommodate multiple filter types for multiple filtration applications. In essence, current filtration systems have the inconvenience of being “frozen” at the time of manufacture for one specific fumehood housing configuration.

Thus, to date, there is still the need for a ductless fumehood which provides (i) a modular, housing-free filtration system, and (ii) remote intercommunication management means designed to monitor the condition of the working elements and safety components.

### SUMMARY OF THE INVENTION

These and other problems associated with conventional ductless fumehoods are addressed by the present invention, which comprises a unique, modular ductless fumehood system comprising at least one ductless fumehood and a remote monitor unit, wherein the at least one ductless fumehood is connected to the remote monitor unit through a communication link, such that the remote monitor unit can monitor one or more ductless fumehoods from a central location and provide alerts to an operator located at the ductless fumehood, or to others located at another location, when a failure is detected at a ductless fumehood.

In one form of the present invention, there is provided a modular filtration column for use with a ductless fumehood, the modular filtration column comprising:

a plurality of cassettes having an identical footprint;

at least one of the cassettes being configured to move air through the modular filtration column;

at least one of the cassettes being configured to filter air moving through the modular filtration column; and

at least one seal mechanism for providing an air-tight seal between adjacent cassettes, wherein the at least one seal mechanism is configured to form an air-tight seal devoid of any external compressive force.

In another form of the present invention, there is provided an air treatment system comprising:

a ductless fumehood; and

a modular filtration column for treating air entering and/or exiting the ductless fumehood, the modular filtration column comprising:
a plurality of cassettes having an identical footprint;
at least one of the cassettes being configured to move air through the modular filtration column;
at least one of the cassettes being configured to filter air moving through the modular filtration column; and
at least one seal mechanism for providing an air-tight seal between adjacent cassettes, wherein the at least one seal mechanism is configured to form an air-tight seal devoid of any external compressive force.

In another form of the present invention, there is provided a method for filtering air entering and/or exiting a ductless fumehood, the method comprising the steps of:

determining the material to be filtered from the air entering and/or exiting the ductless fumehood;

determining the rate of flow of the air entering and/or exiting the ductless fumehood;

providing a modular filtration column for treating air entering and/or exiting the ductless fumehood, the modular filtration column comprising:
a plurality of cassettes having an identical footprint;
at least one of the cassettes being configured to move air through the modular filtration column;
at least one of the cassettes being configured to filter air moving through the modular filtration column; and
at least one seal mechanism for providing an air-tight seal between adjacent cassettes, wherein the at least one seal mechanism is configured to form an air-tight seal devoid of any external compressive force;

wherein the number and capacity of the cassette(s) configured to move air through the modular filtration column is in accordance with the determined rate of flow of the air entering and/or exiting the ductless fumehood; and

wherein the number and type of the cassette(s) configured to filter air moving through the modular filtration column is in accordance with the determined material to be filtered from the air entering and/or exiting the ductless fumehood.

### BRIEF DESCRIPTION OF THE DRAWINGS

These and other objects and features of the present invention will be more fully disclosed or rendered obvious by the following detailed description of the preferred embodiments of the present invention, which are to be considered together with the accompanying drawings wherein like numbers refer to like parts and further wherein:

FIG. 1 is a schematic view showing a prior art ductless fumehood;

FIG. 2 is a schematic view showing a novel ductless fumehood system formed in accordance with the present invention;

FIG. 3 is a schematic view of a novel ductless fumehood formed in accordance with the present invention;

FIGS. 4 and 5 are an exemplary validation questionnaire for determining the appropriate filter to be used for a given chemical;

FIG. 6 is an exemplary listing showing the appropriate filter to be used for a given chemical; and

FIG. 7 is a schematic view showing an exemplary magnetic card for identification and for activation of a fumehood;

FIG. 8 is a schematic view showing a novel fumehood incorporating a master module and one slave module;

FIG. 9 is a schematic view showing modular filter cassettes formed in accordance with the present invention;

FIGS. 10-15 are schematic views showing cassette-connecting seal configurations used in accordance with the present invention;

FIG. 16 is a schematic view showing a filtration column mounted to a ductless fumehood, wherein the filtration column is formed in accordance with the present invention; and

FIG. 17 is a schematic view showing the “reversibility” of individual cassettes.

### DETAILED DESCRIPTION OF THE PREFERRED EMBODIMENTS

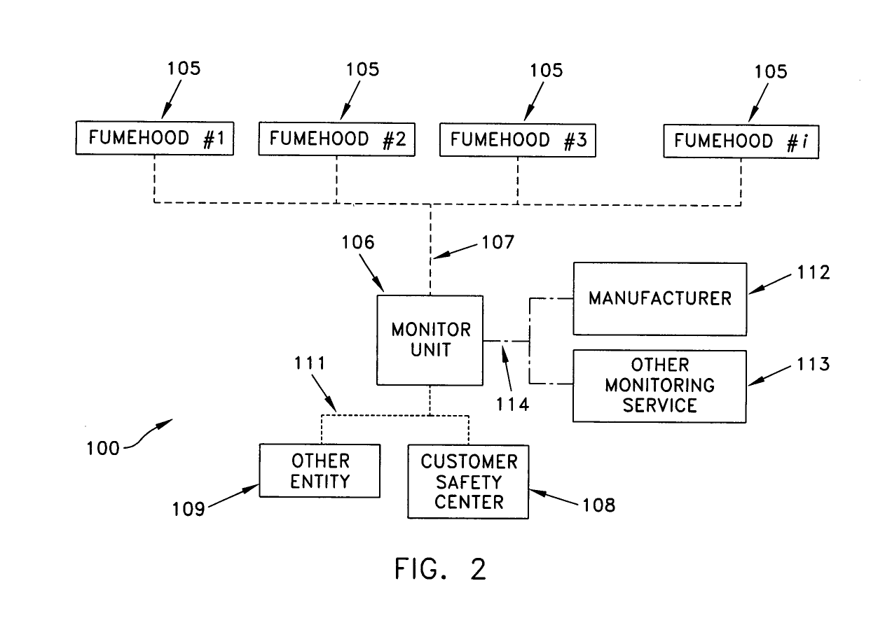

Looking next at FIG. 2, there is shown a ductless fumehood system 100 formed in accordance with the present invention. Ductless fumehood system 100 generally comprises at least one, and preferably a plurality of, ductless fumehoods 105, and a remote monitor unit 106, wherein ductless fumehoods 105 are connected to remote monitor unit 106 through a communication link 107, such that remote monitor unit 106 can monitor ductless fumehoods 105 from a central location and provide alerts to an operator located at a ductless fumehood when a failure is detected at that ductless fumehood. Communication link 107 may be a “hard-wired” connection (e.g., electrical wire or optical fiber) or a “wireless” connection (e.g., an RF link or a cellular telephone link). Furthermore, communication link 107 may utilize a conventional or proprietary protocol. By way of example but not limitation, communication link 107 may comprise a WIFI connection.

Additionally, remote monitor unit 106 may also be connected to a customer safety center 108 and/or other entity 109 (e.g., a local fire department) via a communication link 111, in order to provide alerts to those parties when a failure is detected at that ductless fumehood. Communication link 111 may be a “hard-wired” connection (e.g., electrical wire or optical fiber) or a “wireless” connection (e.g., an RF link or a cellular telephone link). Furthermore, communication link 111 may utilize a conventional or proprietary protocol. By way of example but not limitation, communication link 111 may comprise an Ethernet connection.

Furthermore, remote monitor unit 106 may also be connected to the system's manufacturer 112 and/or to an other monitoring service 113 via a communication link 114, in order to provide alerts to those parties when a failure is detected at that ductless fumehood. Communication link 114 may be a “hard-wired” connection (e.g., electrical wire or optical fiber) or a “wireless” connection (e.g., an RF link or a cellular telephone link). Furthermore, communication link 114 may utilize a conventional or proprietary protocol. By way of example but not limitation, communication link 114 may comprise a conventional telephone connection.

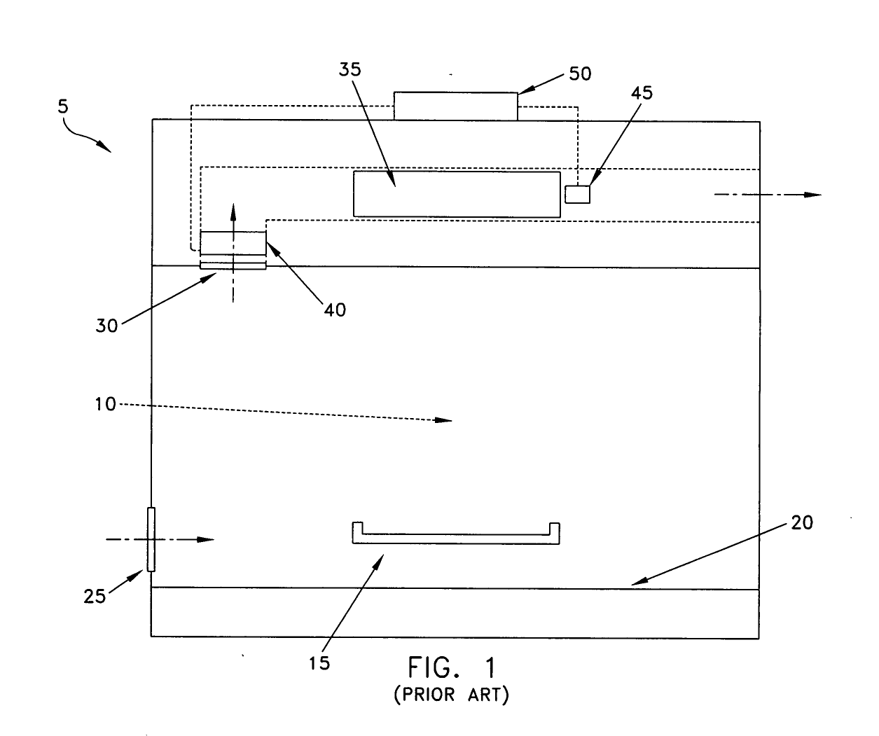

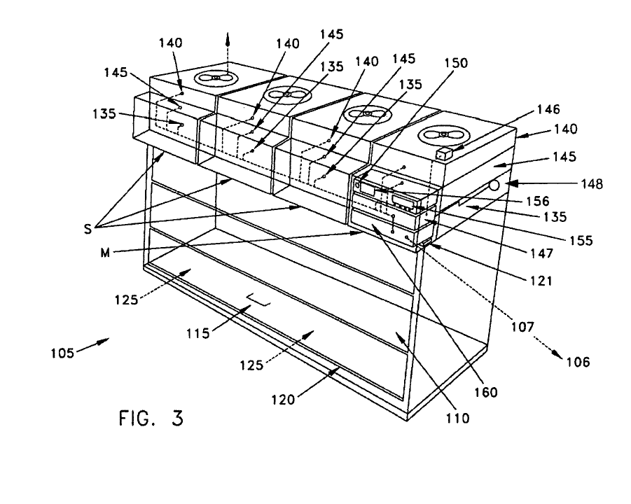

More particularly, and looking now at FIG. 3, there is shown a novel ductless fumehood 105. Ductless fumehood 105 generally comprises an enclosed workspace 110 accessed by a front door 115, with front door 115 engaging a sash 120 when the enclosed workspace is “sealed”. An air inlet 125 admits ambient air into enclosed workspace 110. Air inlet 125 may be a side wall opening similar to the air inlet 25 shown in FIG. 1; more preferably, however, air inlet 125 may comprise one or more gaps formed between the base of front door 115 and the top of sash 120 when front door 115 is in its fully closed position.

Each ductless fumehood 105 also comprises a master module M and, optionally, one or more slave modules S for providing air filtration functions. Master module M also provides control and monitoring functions as will hereinafter be discussed in detail. By way of example but not limitation, the ductless fumehood shown in FIG. 3 comprises one master module M and three slave modules S.

As noted above, master module M provides air filtration functions. To this end, master module M draws air out of workspace 110 and passes that air through a filter before the air is released to the ambient air (e.g., the room air within a laboratory). More particularly, master module M includes, among other things, a filter 135 for removing hazardous substances from the air as the air is drawn through master module M, thereby rendering the air safe before it is vented to the ambient air. In this respect it will be appreciated that the filter media used in filter 135 may vary in accordance with the specific substance which is to removed from the air, e.g., for many applications, filter 135 may comprise activated carbon granules captivated between a pair of screens. An outlet fan 140 is provided so as to draw air from the enclosed workspace 110 through filter 135 before being vented to the atmosphere. A filter sensor 145 is provided at the outlet of filter 135 so as to ensure that the filter purges any hazardous substances from the workspace air before that air is vented to the ambient air. An ambient air sensor 146 is mounted to the exterior of master module M to monitor the ambient air in the vicinity of ductless fumehood 105. Master module M also comprises a sash monitor 121 to confirm when front door 115 is in its closed (i.e., sealed) position against sash 120.

In accordance with the present invention, master module M also comprises a central processing unit 147. It will be appreciated that central processing unit 147 comprises appropriate electronics and software in order that central processing unit 147 may control operation of the active elements of master module M, detect any failures of the components of master module M, and also function in the manner hereinafter described. Central processing unit 147 is connected to the aforementioned sash monitor 121, outlet fan 140, filter sensor 145 and ambient air sensor 146.

Preferably, a temperature sensor 148 is also provided on filter 135. Temperature sensor 148 is connected to central processing unit 147 and is adapted to monitor the temperature of air passing through filter 135. As a result, the system is able to detect unusual or unsafe temperature conditions, e.g., the system can detect the occurrence of a fire within enclosed workspace 110.

Central processing unit 147 is also connected to an alarm 150 which can alert the operator in the event that there is a system failure, and central processing unit 147 is connected to a display monitor 155 (e.g., a touchscreen display, or other user interface such as a computer monitor and keyboard, etc.) in order that the operator may interface with central processing unit 147. Central processing unit 147 is also connected to a communication interface 160 which is connected to the aforementioned communication link 107, whereby central processing unit 147 may communicate with remote monitor unit 106.

By virtue of the foregoing construction, central processing unit 147 is able to detect when there is a system failure. More particularly, central processing unit 147 is capable of detecting when front door 115 is open (by virtue of sash monitor 121), and/or if outlet fan 140 has failed and/or if filter 135 is not operating properly (by virtue of filter sensor 145). When such a system failure is detected, central processing unit 147 activates alarm 150 (and may flash an alert on display monitor 155) so as to alert the operator. At the same time, central processing unit 147 also alerts remote monitor unit 106 via communication link 107. Remote monitor unit 106 can then alert customer safety center 108 and/or some other entity 109 via communication link 111, as well as alert manufacturer 112 or some other monitoring service 113 via communication link 114. Thus, failures in any of the ductless fumehoods 105 can be monitored remotely via remote monitor unit 106, thereby making it practical and convenient to operate large numbers of ductless fumehoods 105 in a safe and reliable manner.

Furthermore, inasmuch as central processing unit 147 is connected to ambient air sensor 146, the system is also capable of monitoring ambient air conditions in the vicinity of each ductless fumehood 105. Thus, the system also provides a means for detecting the presence of hazardous substances in the air around each ductless fumehood 105. Significantly, the system is capable of detecting the presence of hazardous substances which may emanate from sources other than the ductless fumehood itself, e.g., the hazardous substances may emanate from a chemical spill elsewhere in the laboratory.

Furthermore, inasmuch as each master module M includes both a filter sensor 145 and an ambient sensor 146, the system is capable of differentiating a global hazard from a local hazard. More particularly, when filter sensor 145 is detecting the presence of a hazardous substance and ambient sensor 146 is not, the hazard is likely to be associated with a local filter failure. However, when filter sensor 145 is not detecting the presence of a hazardous substance and ambient sensor 146 is, the hazard is likely to be associated with a global hazard event.

In addition to the foregoing, central processing units 147, remote monitor unit 106, and/or any of the other entities (e.g., customer safety center 108, other entity 109, manufacturer 112, and/or other monitoring service 113) may keep a log of system operation. Logged events may include system failures, filter replacements, door openings, responsiveness of operators to alerts, etc.

As noted above, each ductless fumehood 105 may also comprise one or more slave modules S. Slave modules S also provide air filtration functions. To this end, each slave module S comprises a filter 135, a filter sensor 145 and an outlet fan 140. Outlet fan 140 draws air from workspace 110 up through filter 135 before venting the filtered air into the ambient room atmosphere. Filter sensor 145 monitors the function of filter 135. Thus, each slave module S is capable of purging unwanted substances from the air within workspace 110 before venting that air into the ambient room atmosphere. Significantly, each slave module S in ductless fumehood 105 is electrically connected to the master module M provided for that ductless fumehood, in order that central processing unit 147 can control operation of the active elements of each slave module S and detect any failures in any of the components (e.g., filter sensor 145 or outlet fan 140) of any of the slave modules S.

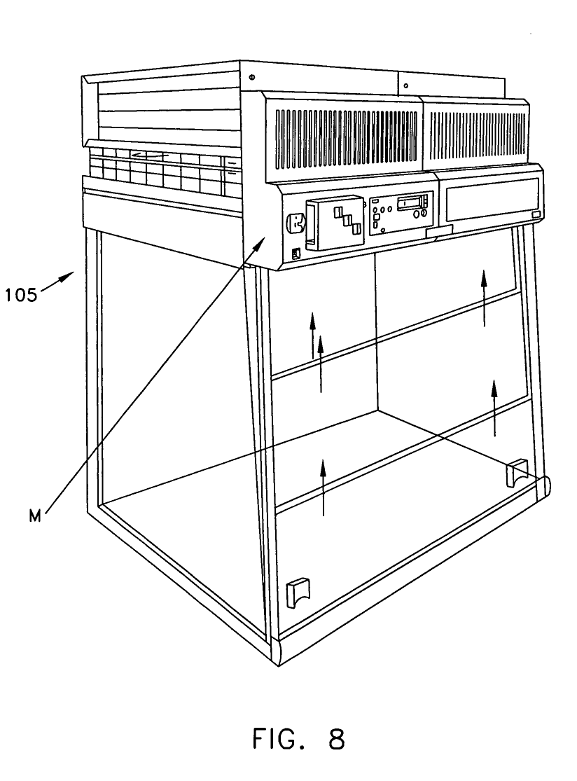

Thus it will be seen that each ductless fumehood 105 includes an enclosed workspace 110 and a master module M, and may include one or more slave modules S. In fact, each ductless fumehood 105 includes as many slave modules S as are necessary to provide, in conjunction with the air filtering capacity already provided by that fumehood's master module M, the appropriate filter capacity for workspace 110. Thus, for a ductless fumehood 105 having a length X, one master module M and no slave modules S might be provided; for a ductless fumehood 105 having a length (X+Y), one master module M and one slave module S might be provided (FIG. 8); for a ductless fumehood 105 having a length (X+Y+Z), one master module M and three slave modules S might be provided (FIG. 3). In essence, any desired filter capacity can be provided for any ductless fumehood, simply providing one master module M and as many slave modules S as may be needed.

Thus it will be seen that manufacturing, inventory and service requirements will be dramatically reduced through use of the present invention, since only two types of air filtering modules (i.e., master modules M and slave modules S) need be manufactured, inventoried and serviced, regardless of the size ductless fumehoods which are to be produced. In fact, in this respect it should be appreciated that slave modules S are in essence a simplified form of master module M, since they include the air filtering components (e.g., filter 135, filter sensor 145 and outlet fan 140) but omit the control and communication components (e.g., central processing unit 147, communications interface 160, etc.). Or viewed another way, the master module M is essentially an enhanced form of slave module S, since the master module includes components in addition to those provided in a slave module S (e.g., the control and communication components). As a result, slave modules S and master modules M can share many common elements, thereby further simplifying manufacturing, inventory and service requirements, and hence further reducing cost. In fact, before receiving the components that differentiate the master modules M from the slave modules S, the modules are identical to one another, and therefore can be manufactured in high volumes, which provides a substantial economic advantage.

Central processing unit 147 may also, in conjunction with other appropriate hardware, provide additional functionality to the ductless fumehood 105. This functionality may include, but is not limited to:

(i) the provision of an audio-visual video program displayed on an appropriately-sized display monitor 155—the program could be a live or pre-recorded audio-visual feed designed to provide a user with relevant information—by way of example but not limitation, the program could be intended to provide students with remote access to experiments performed within another ductless fumehood by a professor, or the program might intended to provide students with a step-by-step procedure for conducting an experiment; and/or

(ii) the provision of a database identifying those chemicals for which operation of the ductless fumehood is approved; and/or

(iii) a sensor detecting the presence or absence of filters in the ductless fumehood; and/or

(iv) a bar code reader allowing the fast and accurate identification of chemicals which will be used within the fumehood—the bar code reader allows universal product codes (UPC) to be read from the labels on the chemical containers, etc.

Central processing unit 147 is preferably also programmed to manage, in an interactive manner, each of the functions of each of the modules, in order to ensure that each of the modules remains within its operational limits as determined by the manufacturer.

The central processing unit is preferably configured in such a way that it transfers all of the data gathered for its associated ductless fumehood to the communications interface 160, for subsequent transfer to remote monitor unit 106.

The information emitted by each or all of the ductless fumehoods 105 is then preferably gathered by an appropriate wireless transmitter/receiver placed within a computer separate from each or all of the ductless filtering fume hoods (i.e., remote monitor unit 106). This computer is programmed to interactively manage the information coming from each or all of the ductless fumehoods. This information can be placed at the disposal of the person or persons in charge of safety so as to permit them to remotely manage one or all of the ductless fumehoods in order to ensure proper functioning or maintenance. In other words, remote monitor unit 106 can report to customer safety center 108, and/or an other entity 109, and/or manufacturer 112 and/or other monitoring service 113.

With this arrangement it is possible to send the information gathered by the system at one or all of the ductless fumehoods, via the Internet or other communication link, to another location, in order to be managed by another entity, for example, a service and control department of the manufacturer.

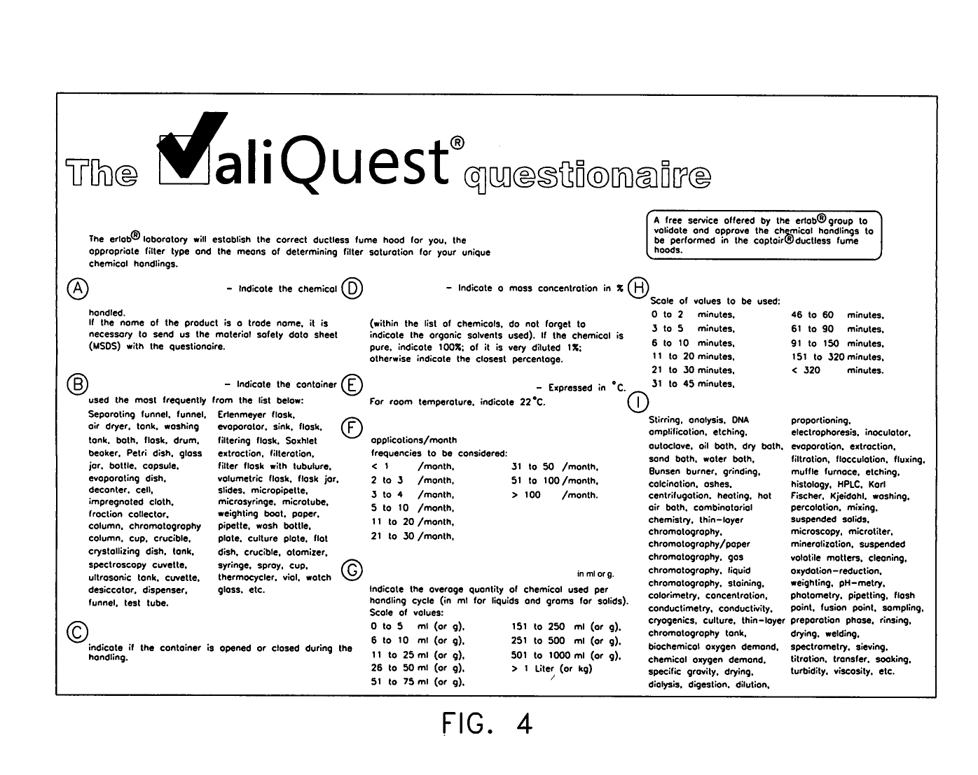

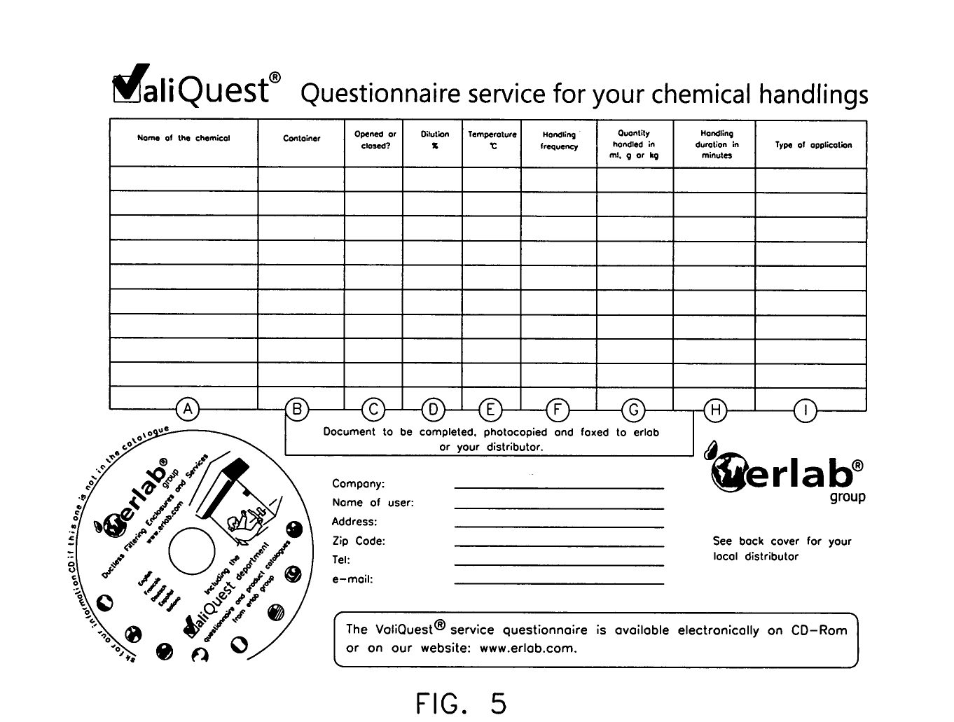

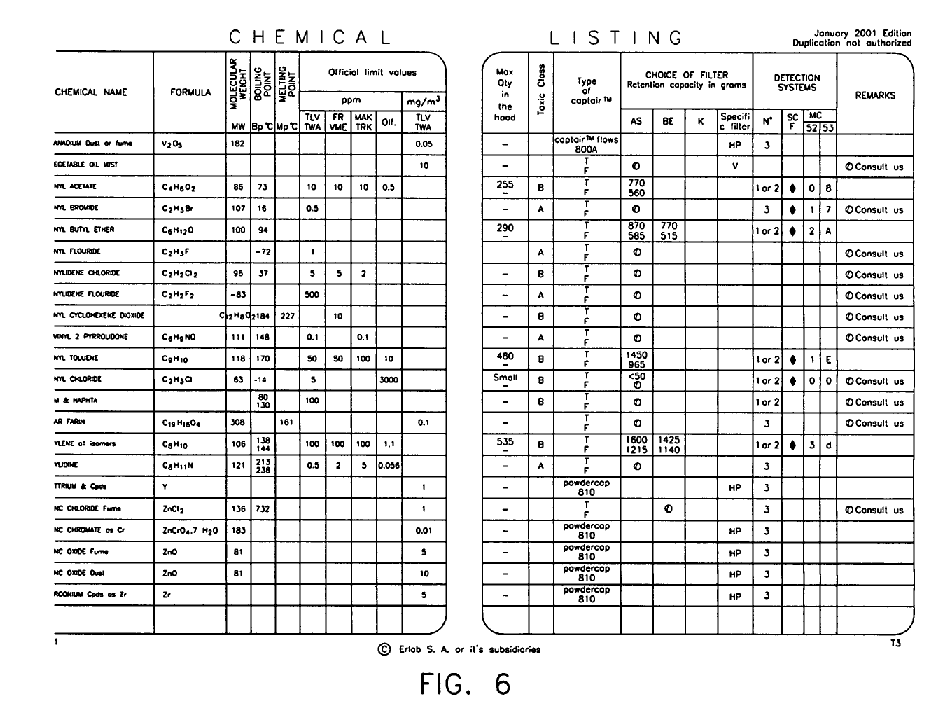

In one preferred form of the present invention, prior to purchasing the ductless fumehoods, a questionnaire (see FIGS. 4 and 5) is provided to the user who, in turn, indicates the chemicals that he/she intends to use within the ductless fumehood. Upon receipt of this data, the manufacturer validates the use of the ductless fumehood for the intended chemicals (see FIG. 6).

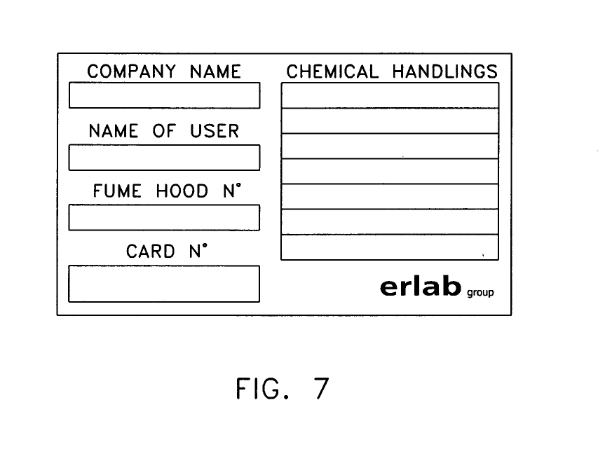

Preferably, upon receipt of a purchase order from the user, the manufacturer provides an access card (preferably similar to a credit card) on which is recorded various pertinent information, including the chemicals previously validated for use in the fumehood. See FIG. 7. This access card preferably indicates the name of the user who completed the questionnaire, and the access card is used by the user to operate (i.e., turn on or off) the ductless fumehood. In order for this operation to take place, the ductless fumehood is equipped with an electronic card reader 156 (see FIG. 3) for regulating fumehood use. The user inserts their access card into the card reader and the access card will remain there during use of the ductless fumehood. Removing the access card turns off the ductless fumehood. Furthermore, the access card provides a means for limiting use of the fumehood to authorized users.

FIG. 8 is a schematic view showing a ductless fumehood 105 utilizing one master module M and one slave module S.

### Additional Comments Regarding The Invention

Thus it will be seen that, with the present invention, a number of sensors and interactive detectors placed within the ductless filtering fume hood modules are linked to a processor (e.g., a central processing unit) placed within one of the modules (e.g., the master module M) that controls the active elements of all the other modules (e.g., the slave or “dummy” modules S); for example, sensors and detectors are placed within elements such as, but not limited to, fans or blowers, face velocity meters, gas detectors and lighting. This processor also controls the activation of the working modules that constitute the ductless filtering fumehood. In other words, these sensors and detectors are linked to the management processor and to all of the functions (provided or to be provided) of all of the modules that make up the ductless filtering fumehood such as, for example: an audio-visual video system designed to provide students with remote access to experiments performed within the hood by a professor in cases when the ductless filtering fumehood is used in the educational sector, or a database allowing the operation of a chemical listing, or a sensor detecting the presence of filters, or also a bar code reader allowing the identification of chemical molecules from the bottles that contain them, etc. The electronic processor is programmed to manage in an interactive manner each of the functions of the modules so that they react and act upon the elements of the modules of the ductless filtering fumehood in order to maintain within their limits the settings determined by the manufacturer.

This central processing unit is configured in such a way that it transfers all of the gathered information towards an electronic board placed within the main or master module M that reads the information and also transfers this information towards a remote transmitting and receiving wireless system also placed within the master module M.

The information emitted by each or all of the ductless filtering fumehoods is then gathered by an appropriate wireless transmitter receiver placed within a computer separate from each or all of the ductless filtering fumehoods. This computer is equipped with a program specially designed by the manufacturer of the ductless filtering fumehood to interactively manage each or all of the information coming from each or all of the ductless filtering fumehoods. This construction can be placed at the disposal of the person or people in charge of safety so as to permit them to remotely manage one or all ductless filtering fumehoods in order to insure proper functioning or maintenance.

With this arrangement it will also be possible to send the information gathered by the system of one or all of the ductless filtering fumehoods, via the Internet, in order to be managed by a service and control department of the manufacturer.

The filtration portion of the ductless filtering fumehood is comprised of one or more filtration modules that make up, by multiplication, the length of the hood. For example the modules will preferentially have a length of 40 centimeters or 16 inches. The command or main module M will be linked to the other slave or “dummy” modules S by electrical connectors so that the interactivity of commands or information coming from the central processing unit (found on the command or main module M) can be transferred to the active elements of all the modules. The inconveniences coming from the use of non-modular systems to constitute a multitude of fumehood sizes have been described above. The advantages of using modular systems are therefore clear, specifically in the case of putting together an intercommunication system such as the one described above.

### Reversed Airflow

In the preceding discussion, ductless fumehood 105 is discussed in the context of a fumehood designed to protect personnel and the environment from the contents of workspace 110, i.e., filter 135 filters air as that air passes from workspace 110 to the ambient room atmosphere. However, it should also be appreciated that the present invention can be applied to situations where ductless fumehood 105 is designed to protect the contents of workspace 110 from substances in the ambient room air. In this case, outlet fan 140 is reconfigured so that it operates as an inlet fan, i.e., it moves ambient room air into the fumehood through filter 135, so that the ambient room air is filtered before it is moved into workspace 110. Openings in ductless fumehood 105 then permit the air in workspace 110 to pass back into the ambient room atmosphere.

### Modular Ductless, Housing-Free Filtration System Utilizing Remote Intercommunication Management System

As discussed above, configuring ductless fumehoods in a modular fashion using an intercommunication system provides significant improvements over prior art ductless filtration systems. However, further configuring such a modular, ductless filtration system so as to be “housing-free” would provide increased flexibility in both configuration and application for the user, as well as decreased manufacturing and inventory costs for the manufacturer.

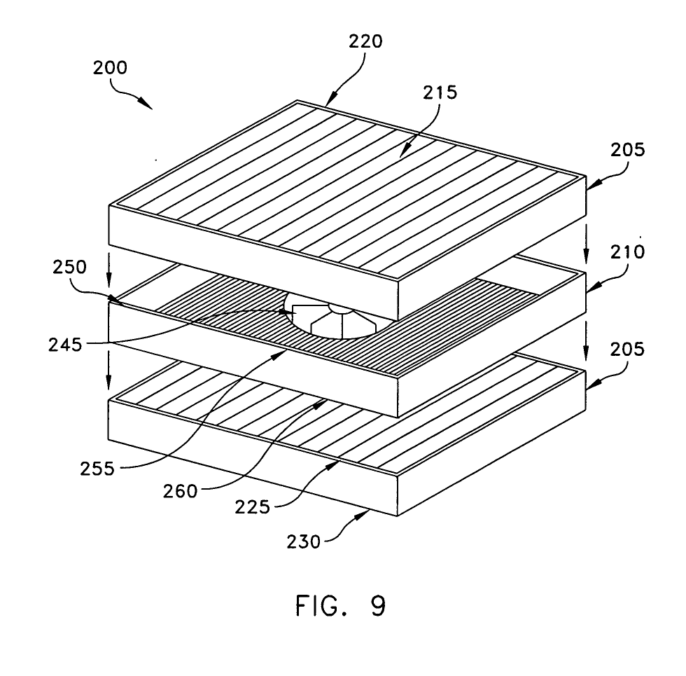

In accordance with the present invention, and looking now at FIG. 9, there is provided a novel ductless, housing-free filtration system 200. Ductless, housing-free filtration system 200 generally comprises at least one filter cassette 205 and at least one fan/blower cassette 210. Filter cassette(s) 205 and fan/blower cassette(s) 210 are configured so as to be interchangeably “stackable” with respect to one another, in any number and in any sequence, as will hereinafter be discussed in greater detail.

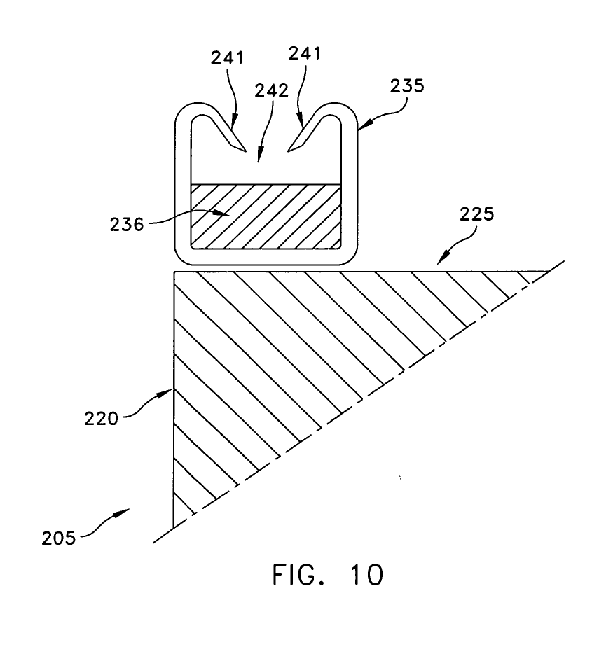

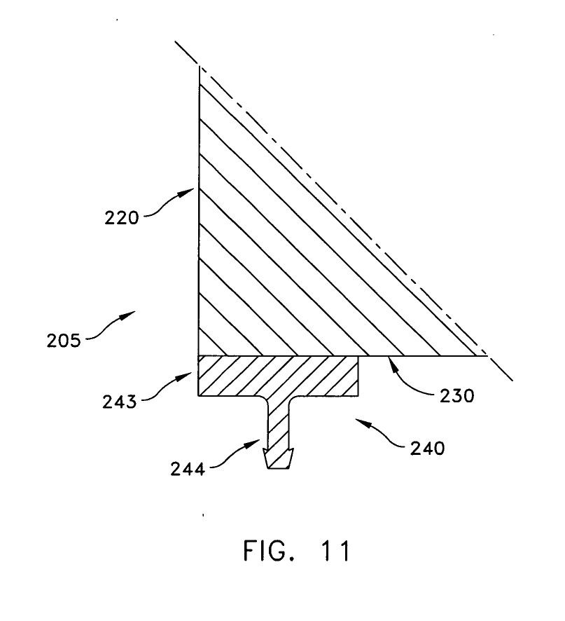

Looking next at FIGS. 9-11, filter cassette 205 preferably comprises a filter 215 contained within an outer frame 220. Filter 215 may comprise any filter type well known in the art (e.g., a granulated carbon filter) for use in a specific filtration application (i.e., for purging unwanted chemicals from air). Outer frame 220 of filter cassette 205 comprises an upper edge 225 and a lower edge 230. Upper edge 225 (FIG. 10) preferably comprises a seal groove 235. Seal groove 235 is preferably provided with a reusable sealant material 236, as will hereinafter be discussed in further detail. The reusable sealant material is preferably one of the commercially-available gel-sealants, although it may be another sealant material in the form of a liquid, semi-solid, etc. Lower edge 230 (FIG. 11) preferably comprises a seal tongue 240.

Preferably, seal groove 235 (FIG. 10) is constructed as a partially-capped trough terminating on its upper end in a pair of diametrically-opposed lips 241 separated by an access slit 242. Seal tongue 240 (FIG. 11) is preferably configured as a T-shaped structure defined by a base 243 and a projecting blade 244.

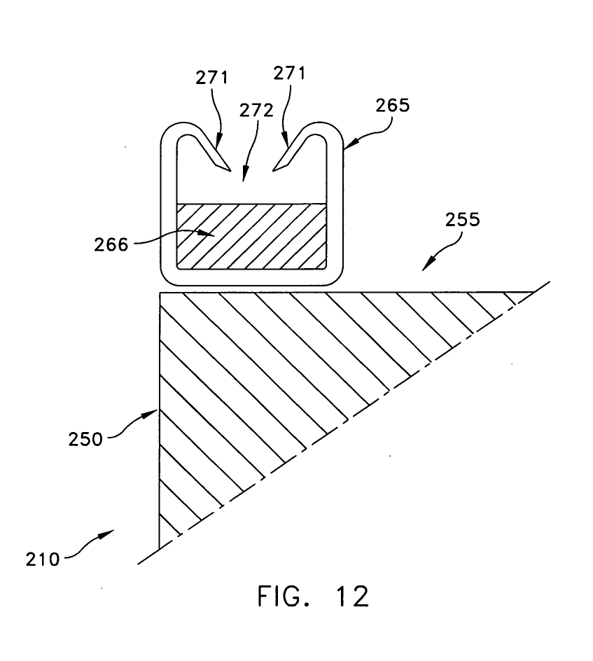

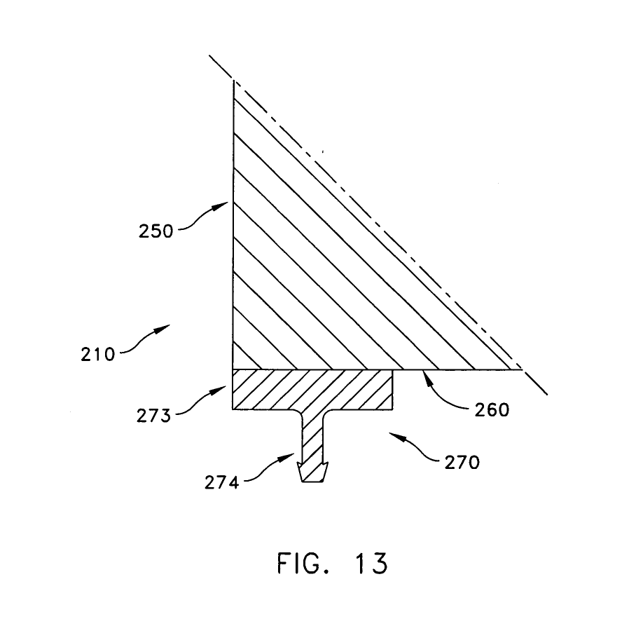

Looking next at FIGS. 9, 12 and 13, fan/blower cassette 210 preferably comprises a fan/blower unit 245 contained within an outer frame 250. Fan/blower unit 245 can be configured to move air upward through fan/blower cassette 210 (in which case it will draw air out of a ductless fumehood) or move air downward through fan/blower cassette 210 (in which case it will force air into a ductless fumehood). Power is preferably delivered to fan/blower unit 245 using an external power supply. Outer frame 250 of fan/blower cassette 210, like outer frame 220 of filter cassette 205, comprises an upper edge 255 and a lower edge 260. Upper edge 255 (FIG. 12) preferably comprises a seal groove 265. Seal groove 265 is preferably provided with a reusable sealant material 266, as will hereinafter be discussed in further detail. The reusable sealant material is preferably one of the commercially-available gel-sealants, although it may be another sealant material in the form of a liquid, semi-solid, etc. Lower edge 260 (FIG. 13) preferably comprises a seal tongue 270.

Preferably, seal groove 265 (FIG. 12) is constructed as a partially-capped trough terminating on its upper end in a pair of diametrically-opposed lips 271 separated by an access slit 272. Seal tongue 270 (FIG. 13) is preferably configured as a T-shaped structure defined by a base 273 and a projecting blade 274.

It should be appreciated that, as will hereinafter be discussed in further detail, seal tongues 240, 270 are configured to mate with seal grooves 235, 265 in a male/female connection, with reusable sealant material 236, 266 forming an air-tight seal around a projecting blade 244, 274.

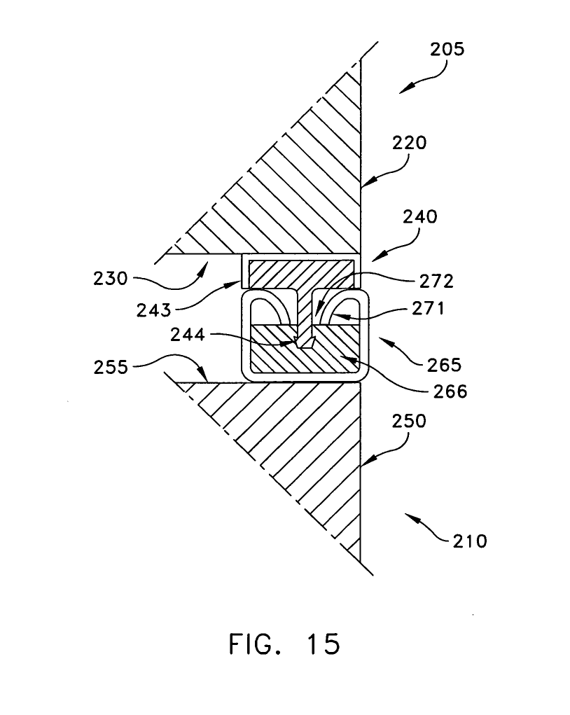

More particularly, projecting blades 244, 274 of seal tongues 240, 270 are intended to be received by access slits 242, 272 of seal grooves 235, 265, with bases 243, 273 of seal tongues 240, 270 seating atop diametrically-opposed lips 241, 271. Projecting blades 244, 274 are sized so that when bases 243, 273 of seal tongues 240, 270 are seated atop diametrically-opposed lips 241, 271, projecting blades 244, 274 extend into sealant material 236, 266 contained within seal grooves 235, 265 without contacting the floors of seal grooves 235, 265. Preferably, projecting blades 244, 274 make a close sliding fit with diametrically-opposed lips 241, 271 so as to provide vertical alignment between adjacent cassettes and prohibit side-to-side movement between the cassettes. By sizing the elements so that projecting blades 244, 274 terminate short of the floors of seal grooves 235, 265, a positive stop (i.e., the engagement of seal bases 243, 273 atop diametrically-opposed lips 241, 271) is provided so as to prevent excessive seal compression and to avoid seal damage (e.g., damage to projecting blades 244, 274 and/or seal grooves 235, 265, and/or sealant materials 236, 266). See, for example, FIG. 15. In addition, this positive stop provides a stable mounting mechanism between adjacent cassettes. This positive stop, stable mounting mechanism becomes increasingly important as the filtration column extends in cassette number and height, and as the weight imposed on the underlying cassettes increases.

As seen in FIG. 9, filter cassette(s) 205 and fan/blower cassette(s) 210 are configured so as to have the same geometric “footprint” (i.e., outer frame 220 of filter cassette 205 is configured so as to have an identical shape and perimeter as outer frame 250 of fan/blower cassette 210). It should be appreciated that by configuring both filter cassette(s) 205 and fan/blower cassette(s) 210 with the same footprint, filter cassette(s) 205 and fan/blower cassette(s) 210 can be readily aligned, and stacked, so as to form a housing-free filtration column.

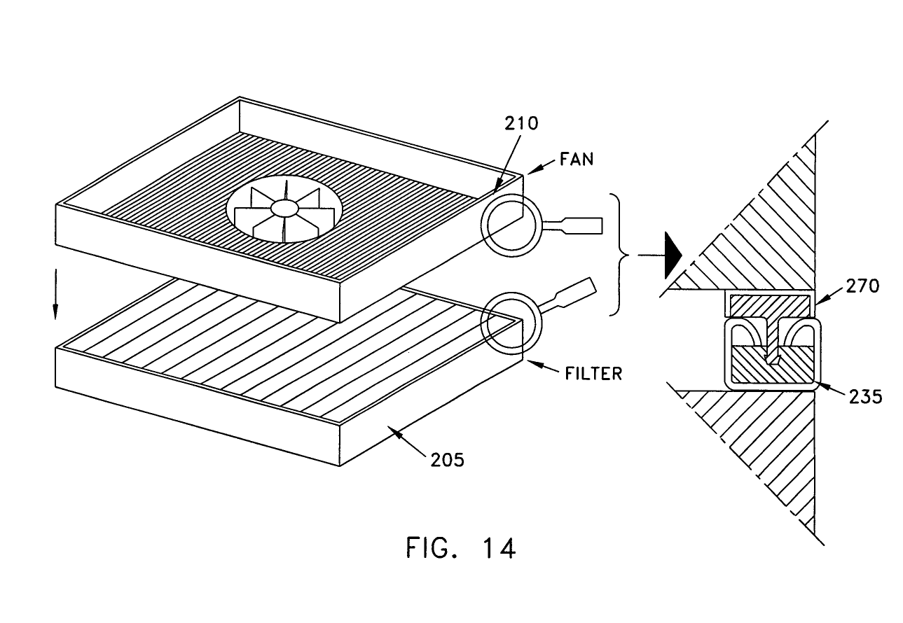

For purposes of illustration, consider the housing-free filtration column shown in FIG. 9 which comprises three cassettes: a lower cassette 205, one fan/blower cassette 210 and an upper filter cassette 205. When fan/blower cassette 210 is positioned on top of the lower filter cassette 205, seal tongue 270 of fan/blower cassette 210 aligns with, and seats into, seal groove 235 (FIG. 14). Reusable sealant material 237 disposed within seal groove 235 receives seal tongue 270 and forms an air-tight seal between seal tongue 270 and seal groove 235, and hence between fan/blower cassette 210 and filter cassette 205.

Second filter cassette 205 can thereafter be positioned on top of fan/blower cassette 210, with seal tongue 240 aligned with, and seated into, seal groove 265 (FIG. 15). As this occurs, diametrically-opposed lips 261 help guide projecting blade 264 into, and through, access slit 272. Again, reusable sealant material 266 disposed within seal groove 265 receives seal tongue 240 and forms an air-tight seal between seal tongue 240 and seal groove 265, and hence between upper filter cassette 205 and fan/blower cassette 210.

It should be appreciated that the weight of a particular cassette (whether it be a filter cassette 205 or a fan/blower cassette 210) placed atop a complete male/female seal is sufficient to provide the compression required to form an air-tight seal between that cassette and the cassette immediately below it. In other words, no external or other integrated mechanism is required in order to form the air-tight seal between stacked adjacent cassettes, or the housing-free filtration column as a whole.

In addition to providing air-tightness to the filtration column, the seals achieved by the male/female connections and the reusable sealant material incorporated therein also provide for ease in alignment and protection from over-compression. As noted above, the engagement of bases 243, 273 with diametrically-opposed lips 241, 271 provide a positive mechanical stop between adjacent cassettes, thereby preventing seal over-compression. If desired, additional mechanical stops may also be provided on the cassettes in order to further ensure proper horizontal and vertical positioning during stacking, as well as to prevent too much pressure being applied to a particular seal junction.

In this respect, it should be appreciated that when outer frames 220, 250 of filter cassettes 205 and fan/blower cassettes 210 are stacked atop one another using the aforementioned air-tight seals, the adjacent outer frames of the cassettes and their interposed seals provide the filtration column with an overall enclosed peripheral structure which provides support, protection and an air-tight flow path, without requiring the provision of a traditional housing (and without all of the attendant limitations associated with a traditional housing).

Thus it will be seen that one or more filter cassettes (of identical or varying construction) may be combined with one or more fan/blower cassettes (of identical or varying construction), one on top of another, in any desired number and order, while remaining perfectly aligned, so as to provide a modular filtration column of the desired characteristics.

It should be noted that the reusable sealant material 237, 267 is capable of being used multiple times without losing its sealing qualities. This is important, since it permits the seals to retain their sealing quality even when the cassettes need to be un-stacked and then re-stacked so as to form a different filter column. This construction provides great flexibility in re-stacking cassettes for various filtration applications and needs. More particularly, one cassette combination appropriate for a specific application can be readily reconfigured to an alternative cassette combination as required by another application.

It will be appreciated that the filtration column formed in accordance with the present invention is intended to be mated to a fumehood in an air-tight fashion.

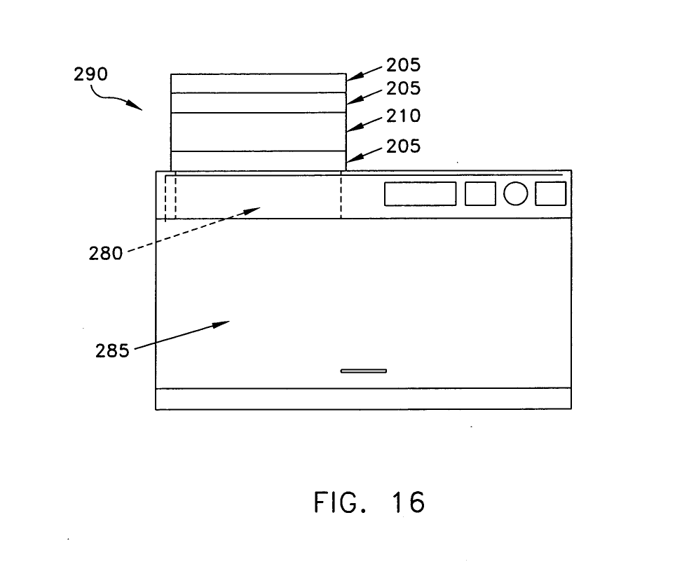

In one preferred approach, and looking now at FIG. 16, the fumehood has an opening 280 leading from its workspace 285 to the modular filtration column 290. Filtration column 290 comprises one or more filter cassettes 205 and one or more fan/blower cassettes 210. For the sake of example, the filtration column 290 will be assumed to have the configuration shown in FIG. 16, i.e., when looking in a top-down direction:
filter cassette
filter cassette
fan/blower cassette
filter cassette
   In this arrangement, the lowermost filter cassette makes an air-tight seal with the upper surface of the fumehood, so that when the sash of the fumehood is closed, air can only pass through the filter column. This is preferably achieved by placing a seal groove (i.e., one like seal grooves 235, 265) on the upper surface of the fumehood about the perimeter of opening 280, so that seal tongue 240 of the lowermost filter cassette seats in the seal groove of the fumehood, whereby to form an air-tight seal of the type previously disclosed.

It should be appreciated that filter cassette(s) 205 and fan/blower cassette(s) 210 may have depths (thicknesses) that are different from one another, according to their specifications. Thus, for example, filter cassette(s) 205 may have one depth and fan/blower cassette(s) 210 may have another depth. Similarly, two filter cassettes 205 might have different depths, depending upon their filters 215, and/or two fan/blower cassettes 210 might have different depths, depending upon their fan/blower units 245.

### Reversibility

As noted above, it may be desirable to reverse the air flow through the filtration column, and hence, the fumehood.

This can be achieved in a number of ways.

More particularly, in one approach the fan/blower cassette may be provided with a fan/blower unit 245 which can change spin direction based on the polarity of current supplied to the fan/blower unit 245.

In another approach, the fan/blower cassette can be supplied in two forms, one form configured to pull air upward and one form configured to push air downward. In this approach, the user selects which type of fan/blower cassette to incorporate into the filtration column.

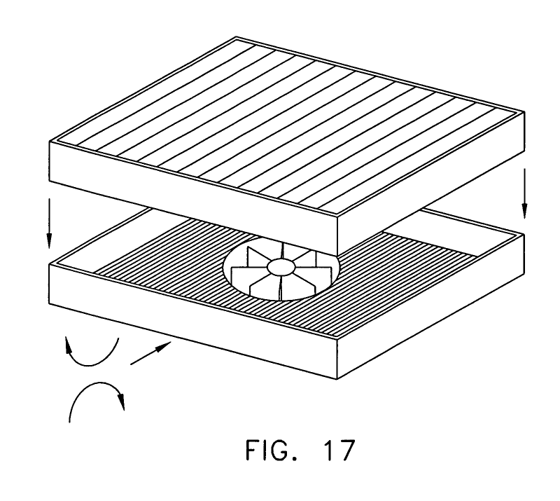

In still another approach, the direction of air flow can be reversed by reversing the orientation of the entire filtration column. In other words, if desired, the cassettes can be stacked so that the upper edges of each cassette instead become the lower edges (i.e., the cassettes are stacked “upside-down”). Looking next at FIG. 17, depending on the position and arrangement within the stack of cassettes, fan/blower cassette 210 can be used to either pull air in through the filtration system, or can be used to blow air out of the filtration system. Likewise, the fan/blower cassette can be used in positive pressure, negative pressure, or in a push-pull configuration.

It should be appreciated that where it is desired to be able to mount the filtration column with “normal” or “reversed” orientation, and where the sealing mechanism utilizes a male/female configuration such as that disclosed above, it will be necessary to provide an appropriate connection to the fumehood so that the lowermost cassette in the filtration column will make an air-tight connection with the fumehood. This may be done by providing an adapter to be used between the lowermost cassette and the fumehood. By way of example but not limitation, where the orientation of the filtration column is reversed and a female seal on the fumehood must be mounted to a female seal on the lowermost cassette, a male/male adapter can be provided for seating between the two female seal components.

Of course, it should be appreciated that the upper edges 225, 255, and lower edges 230, 260 of filter cassette(s) 205 and fan/blower cassette(s) 210 may also comprise alternative complementary sealing means, i.e., ones other than a male/female mount. In this case, if the alternative complementary sealing means are mirror images of one another (i.e., not a male/female arrangement), then it may be possible to reverse the orientation of the filtration column without providing a seal adapter.

### Additional Comments

In addition to the foregoing, the fan/blower cassette can be configured so as to automatically adjust to a pressure drop, which can sometimes result within the filtration system depending on the number of filters used. When using the previously described slave/master filtration system, this adjustment can be configured so as to be automatically provided by the electronic processor fitted to a master module, which is already equipped with a sensor capable of detecting positive and negative pressure and is designed to adjust the air speed through the filter(s).

Significantly, the novel filtration system provides an independent filtration configuration which can function in positive or negative pressure by blowing or drawing air, and is not constrained by (i) a housing with a design which limits the number and type of filter(s), (ii) a filter seal tightening mechanism, or (iii) a pre-determined positioning of the fan/blower.

Thus it will be seen that the present invention provides modularity in a dual sense. First, the present invention provides modularity with respect to the slave/master configuration (which may be conveniently implemented in a “horizontal modularity”). Second, the present invention provides modularity with respect to the user-configurable filter column (which may be conveniently implemented in a “vertical modularity”). It should be appreciated that it is possible to practice the aforementioned slave/master modularity and the filter column modularity independently of one another or, more preferably, in combination with one another.

### Modifications Of The Preferred Embodiments

It should be understood that many additional changes in the details, operation, steps and arrangements of elements, which have been herein described and illustrated in order to explain the nature of the present invention, may be made by those skilled in the art while still remaining within the principles and scope of the invention.

What is claimed is:

1. A modular filtration column for use with a ductless fumehood, the modular filtration column comprising:
a plurality of cassettes having an identical footprint;
at least one of the cassettes being configured to move air through the modular filtration column;
at least one of the cassettes being configured to filter air moving through the modular filtration column; and
at least one seal mechanism for providing an air-tight seal between adjacent cassettes, wherein the at least one seal mechanism is configured to form an air-tight seal devoid of any external compressive force.

2. A modular filtration column according to claim 1 wherein the at least one seal mechanism is configured to form an air-tight seal by utilizing the weight of one cassette on top of another cassette.

3. A modular filtration column according to claim 1 wherein the at least one seal mechanism comprises a male seal component disposed on one cassette and a female seal component disposed on an adjacent cassette.

4. A modular filtration column according to claim 3 wherein the female seal component comprises a groove.

5. A modular filtration column according to claim 4 wherein the groove contains a reusable sealant.

6. A modular filtration column according to claim 5 wherein the reusable sealant comprises a gel sealant.

7. A modular filtration column according to claim 4 wherein the groove comprises a pair of diametrically-opposed lips separated by an access slit.

8. A modular filtration column according to claim 3 wherein the male seal component comprises a projecting blade.

9. A modular filtration column according to claim 7 and further wherein the male seal component comprises a projecting blade sized to be received within the access slit.

10. A modular filtration column according to claim 9 wherein the projecting blade makes a close sliding fit with the pair of diametrically-opposed lips.

11. A modular filtration column according to claim 9 wherein the male seal component further comprises a base, with the projecting blade extending out of the base, and further wherein the base is adapted to engage the pair of diametrically-opposed lips when the projecting blade is received within the access slit.

12. A modular filtration column according to claim 11 wherein the male seal component and the female seal component are sized so that the projecting blade terminates short of the floor of the groove when the base engages the pair of diametrically-opposed lips.

13. A modular filtration column according to claim 3 wherein the male seal component is disposed on the bottom of one cassette and the female seal component is disposed on the top of the underlying cassette.

14. A modular filtration column according to claim 3 wherein the male seal component is disposed on the top of one cassette and the female seal component is disposed on the bottom of the overlying cassette.

15. A modular filtration column according to claim 1 wherein the at least one cassette configured to move air through the modular filtration column comprises a fan/blower unit.

16. A modular filtration column according to claim 1 wherein the at least one cassette configured to filter air moving through the modular filtration column comprises a granulated carbon filter.

17. A modular filtration column according to claim 1 further comprising a second seal mechanism for providing an air-tight seal between an end cassette of the modular filtration column and the ductless fumehood.

18. A modular filtration column according to claim 17 wherein the second seal mechanism comprises a male seal component disposed on one of the end cassette and the ductless fumehood, and a female seal component disposed on the other of the end cassette and the ductless fumehood.

19. A modular filtration column according to claim 1 wherein at least one of the cassettes includes a temperature sensor.

20. An air treatment system comprising:
a ductless fumehood; and
a modular filtration column for treating air entering and/or exiting the ductless fumehood, the modular filtration column comprising:
a plurality of cassettes having an identical footprint;
at least one of the cassettes being configured to move air through the modular filtration column;
at least one of the cassettes being configured to filter air moving through the modular filtration column; and
at least one seal mechanism for providing an air-tight seal between adjacent cassettes, wherein the at least one seal mechanism is configured to form an air-tight seal devoid of any external compressive force.

21. A method for filtering air entering and/or exiting a ductless fumehood, the method comprising the steps of:
determining the material to be filtered from the air entering and/or exiting the ductless fumehood;
determining the rate of flow of the air entering and/or exiting the ductless fumehood;
providing a modular filtration column for treating air entering and/or exiting the ductless fumehood, the modular filtration column comprising:
a plurality of cassettes having an identical footprint;
at least one of the cassettes being configured to move air through the modular filtration column;
at least one of the cassettes being configured to filter air moving through the modular filtration column; and
at least one seal mechanism for providing an air-tight seal between adjacent cassettes, wherein the at least one seal mechanism is configured to form an air-tight seal devoid of any external compressive force;
wherein the number and capacity of the cassette(s) configured to move air through the modular filtration column is in accordance with the determined rate of flow of the air entering and/or exiting the ductless fumehood; and
wherein the number and type of the cassette(s) configured to filter air moving through the modular filtration column is in accordance with the determined material to be filtered from the air entering and/or exiting the ductless fumehood.

22. A method according to claim 21 wherein, after previously providing the modular filtration column in accordance with an earlier set of determinations, the method comprising the further steps of:
re-determining the material to be filtered from the air entering and/or exiting the ductless fumehood;
re-determining the rate of flow of the air entering and/or exiting the ductless fumehood;
providing a re-configured modular filtration column for treating air entering and/or exiting the ductless fumehood, the re-configured modular filtration column comprising:
a plurality of cassettes having an identical footprint;
at least one of the cassettes being configured to move air through the modular filtration column;
at least one of the cassettes being configured to filter air moving through the modular filtration column; and
at least one seal mechanism for providing an air-tight seal between adjacent cassettes, wherein the at least one seal mechanism is configured to form an air-tight seal devoid of any external compressive force;
wherein the number and capacity of the cassette(s) configured to move air through the modular filtration column is in accordance with the re-determined rate of flow of the air entering and/or exiting the ductless fumehood; and
wherein the number and type of the cassette(s) configured to filter air moving through the modular filtration column is in accordance with the re-determined material to be filtered from the air entering and/or exiting the ductless fumehood.
